(19) United States
(12) Patent Application Publication
(10) Pub. No.: US 2006/0184638 A1
(43) Pub. Date: Aug. 17, 2006

(54) Web server for adapted web content

(76) Inventors: Hui Na Chua, Kuala Lumpur (MY); Simon David Malaysia, Kuala Lumpur (MY); See Leng Ng, Selangor (MY); E Ken Pun, Selangor (MY)

Correspondence Address: NIXON & VANDERHYE, PC, 901 NORTH GLEBE ROAD, 11TH FLOOR, ARLINGTON, VA, 22203, US

(21) Appl. No.: 10/546,980

(22) PCT Filed: Mar. 8, 2004
(86) PCT No.: PCT/GB04/00973

§ 371 Date: Aug. 26, 2005

(30) Foreign Application Priority Data
Mar. 17, 2003 (MY) PI20030924
Jun. 24, 2003 (GB) 0314731.1

(51) Int. Cl. G06F 15/16

(52) U.S. Cl. 709/217

(57) ABSTRACT

An apparatus and method for providing adapted web page content to a client are described. Here, a variety of pre-generated versions of the same web content are stored in a server in advance of the receipt of client requests therefore. Each version is adapted to be displayed on a device with particular display characteristics. Then, when a client request for the content is received, the client display characteristics are determined, and the appropriate version for the client display characteristics selected from the stored versions. The selected version is then sent to the client. In a preferred embodiment, if there is no matching version to the client display characteristics, then a matching version is dynamically generated on the fly.

### TECHNICAL FIELD

The present invention relates to a web server and method of operation thereof for providing adapted web page content for display on display devices of differing display capabilities.

### BACKGROUND OF THE INVENTION AND PRIOR ART

To deliver web content to different devices is a process of understanding, re-structuring and tailoring the content in such a way that the content source can be understood and delivered to different devices (such as desktop PCs, PDAs, and mobiles phones) in a manner which suits the device characteristics. Within the prior art (see for example Current Technologies for Device Independent, Mark H Butler, HP Labs Technical Report HPL-2001-83 4 Apr. 2001), there are three presently known ways of doing it:

Firstly, web developers/authors can use web page development software to tailor the content manually to suit different devices, at the web content development stage. By doing this, different versions (e.g. HTML/CSS, WML, XMUXSL) of a single source can be created based on the device capabilities. This approach is the primitive way to deliver web content to different devices, and is a time-consuming and tedious task for web developers/authors if a large number of versions are required.

A second more automated approach is to use a proxy-based trans-coding approach through a proxy server which does the adaptation work on the fly when an end user submits an URI link through a HTTP request. This approach is computing intensive at the proxy server, and has the result that the system response time is slowed. Furthermore, there is no intervention of the original web developers/authors to the adapted web content, which may raise legal and copyright issues in some countries.

A third known technique is to use a client-based (end user device) adaptation approach by installing the adaptation system software at the client side. The client-based adaptation system will adapt the web content on the fly after it receives the result sent back by the requested web server. This approach is computing intensive at the client side, which will consume and degrade the client processing performance. Again, there is no intervention of the original web developers/authors to the adapted web content, which might raise legal and copyright issues as well. Furthermore, this approach is not possible to be applied in small mobile devices due to computation power limitations.

In view of the above, there is a need for a further approach which produces different versions of the same web page content, but which does not possess the drawbacks of the prior art approaches outlined above, and in particular with regards to the computing intensity and system response problems outlined above.

### SUMMARY OF THE INVENTION

In order to meet the above, the present invention provides an apparatus and method for providing adapted web page content to a client. Here, a variety of pre-generated versions of the same web content are stored in a server in advance of the receipt of client requests therefore. Each version is adapted to be displayed on a device with particular display characteristics. Then, when a client request for the content is received, the client display characteristics are determined, and the appropriate version for the client display characteristics selected from the stored versions. The selected version is then sent to the client. In a preferred embodiment, if there is no matching version to the client display characteristics, then a matching version is dynamically generated on the fly.

In view of the above, from a first aspect there is provided a method of providing web page content to a display device, the method comprising:

storing a plurality of different versions of the same web page content, each version being adapted for display on an intended display device having a set of one or more defined display characteristics;

receiving requests for web page content from display devices;

determining the one or more display characteristics of a display device from which a request for web content are received;

selecting a version of the web content stored in the content store in dependence on the respective determined display characteristics of the display device from which a request for web content was received, the selected version being that which is adapted for display on display devices having the determined display characteristics; and

transmitting the selected version to the display device.

The invention according to the first aspect provides the advantages that the response time to service client requests is much reduced, as all the server has to perform is a matching operation to match the client display characteristics to the intended display characteristics of the adapted versions stored in the content store. The actual generation of those adapted versions can be performed off-line in advance.

Preferably there is also further provided the step of adapting said web page content in dependence on the determined display characteristics of the display device from which a request for web content is received so as to provide a version of the web page content adapted for display on the such device, said adapting step being operable in the event that the selecting step determines that there is no version in the content store which is adapted for display on the device having the determined display characteristics.

Additionally, preferably the adapting step further comprises the steps of:

i) analysing the web page content to determine one or more characteristics thereof; and

ii) adapting the web page content to provide the adapted version in dependence on the results of the analysis step. Thus the adaptation process can be modified or controlled to take into account the characteristics of the web content. This improves the adaptation process.

In the above, said analysing step (i) further comprises detecting display objects in said web page content, and calculating the size of said display objects. This is useful in performing the adaptation step.

Additionally, the analysing step may further determine the function of said detected objects. Again, this is useful in performing the adaptation step.

Moreover, the analysing step (i) may further comprise determining the structure of said display objects; and grouping those objects which are determined to have the same or substantially the same structure. This ensures that display objects which are part of a visual structure in the web content are treated together during the adaptation process.

Furthermore, the analysing step (i) may further comprise matching the detected display objects on the basis of their display patterns; and clustering those display objects which match into groups. This additional grouping step ensures that display objects which are not immediately apparent from their structure that they are related, but which nevertheless need to be displayed together for the semantic meaning thereof to be maintained, are dealt with together by the adaptation process.

Within the preferred embodiment, the adapting step preferably further comprises applying one or more content transformations to said web page content. The application of respective transformations in turn allows for close control of the adaptation process to be maintained.

Additionally, within the above where more than one transformation is applied, an evaluation is preferably performed after each transformation to determine whether the transformed content is capable of being displayed on the intended display device, and the transformations are applied in turn until such evaluation indicates that the transformed content is suitable for such display. This ensures that no unnecessary transformations other than those required to meet the intended display device characteristics are performed, and hence the web content is retained to as close to the original content as possible.

From a second aspect, the invention further provides an apparatus for providing web page content to a display device, the apparatus comprising:

a content store arranged to store a plurality of different versions of the same web page content, each version being adapted for display on an intended display device having a set of one or more defined display characteristics;

means for receiving requests for web page content from display devices;

display device characteristic determining means arranged to determine the one or more display characteristics of a display device from which a request for web content are received;

content version selection means arranged to select a version of the web content stored in the content store in dependence on the respective determined display characteristics of the display device from which a request for web content was received, the selected version being that which is adapted for display on display devices having the determined display characteristics; and

means for transmitting the selected version to the display device.

In the second aspect, corresponding advantages are obtained as previously described in respect of the first aspect. Moreover, corresponding further features as described above in respect of the first aspect may also be employed.

From a third aspect, the present invention further provides a computer program or suite of programs so arranged such that when executed by a computer system it/they cause/s the system to perform the process of any of the preceding claims. The computer program or programs may be embodied by a modulated carrier signal incorporating data corresponding to the computer program or at least one of the suite of programs, for example a signal being carried over a network such as the Internet.

Additionally, from a yet further aspect the invention also provides a computer readable storage medium storing a computer program or at least one of suite of computer programs according to the third aspect. The computer readable storage medium may be any magnetic, optical, magneto-optical, solid-state, or other storage medium capable of being read by a computer.

### BRIEF DESCRIPTION OF THE DRAWINGS

Further features and advantages of the present invention will become apparent from the following description of an embodiment thereof, presented by way of example only, and by reference to the accompanying drawings, wherein like reference numerals refer to like parts, and wherein:

FIG. 1 is a system block diagram illustrating the components of the embodiment of the invention, and the signal flows therebetween;

FIG. 2 is a process flow diagram illustrating in more detail how information flows between the components of the embodiment of the invention in operation;

FIG. 3 is a flow diagram for an algorithm to detect characteristics of display objects in web content within the embodiment of the invention;

FIG. 4 is a decision tree to detect the functions of display objects in web content within the embodiment of the invention; and

FIG. 5 is a flow diagram illustrating how content transformations can be applied in the embodiment of the invention.

### DESCRIPTION OF THE EMBODIMENT

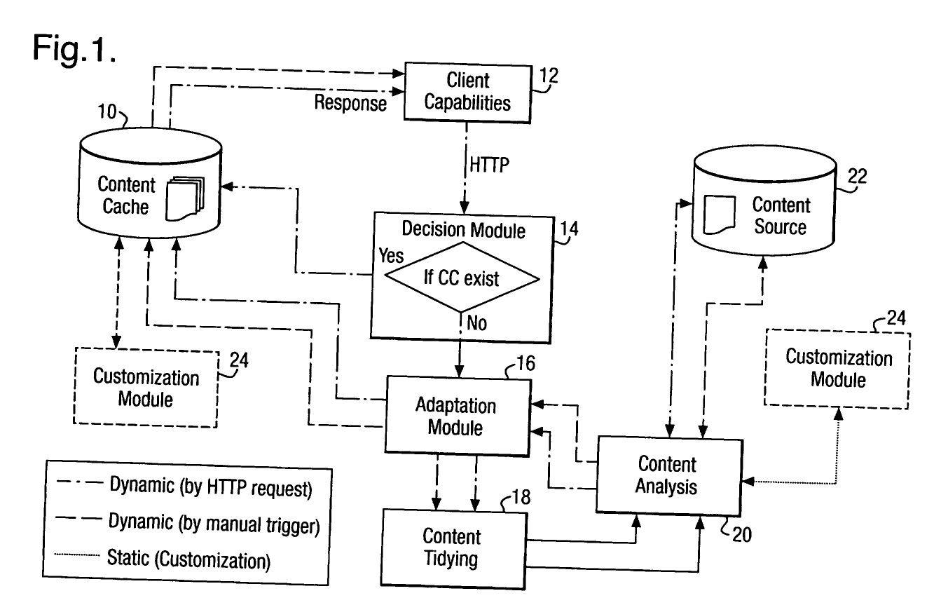

An embodiment of the present invention will now be described with reference to FIGS. 1 to 5.

FIG. 1 is a system block diagram of the system provided by the embodiment of the invention. This system consists of 8 sub-components, as described next. The full operation of the system will be described later.

Firstly there is provided the client capability discovery module 12. The purpose of this module is to discover the end user's device characteristics e.g. type of devices and their capabilities such as screen size/resolution supported, processing power etc., and as such this module receives information from the end user display device relating to its capabilities. The client capability discovery module 12 passes the end users device information to the Decision Module 14.

The Decision module 14 contains existing Client Capabilities profile Ids which were previously detected or predefined by the adaptation system. Client Capabilities profile Ids are sets of information relating to display device display characteristics. In use the Decision module 14 first compares an end user's device characteristics and capabilities (CC) range based on the information sent by Discovery Module with the existing capability profiles. If the client capabilities match an existing profile, then the profile Id of the matching profile is sent to a content Cache 10, in which is stored different versions of pre-generated adapted web content. If the received CC set does not match an existing CC range (i.e. there is no existing CC profile which matches the present requesting device capabilities) then the Adaptation module 16 will be triggered. Additionally, the adaptation module 16 may also be triggered manually to generate different versions of the original web content, without there being a specific request from an end-user.

Howsoever the adaptation module 16 is triggered, the module 16 then acts to examine the http header of the requested web content, and further acts to control a content analysis module 20 to retrieve the requested web content from a web content source store 22. The content analysis module 20 then acts to analyse the indicated web content from the content source store 22, and passes back to the adaptation module 16 a range of parameters relating to the characteristics of the web content as input values to the adaptation module 16. The input parameters received at the adaptation module 16 from the content analysis module 20 enable the adaptation module 16 to adapt the requested web content from the original web content stored in the web contents store 22. The output of the adaptation module 16 is therefore an adapted version of the originally requested web content, and this is sent in an appropriate mark up language such as html to a content cache 10 together with a set of client capability (cc) information, being a set of one or more characteristics of the display of the device requesting the web content. Such display characteristic information was determined by the client capability discovery module 12, as previously described.

In addition to the modules mentioned above, there is also provided, as previously mentioned, a content cache 10 which acts to store different adapted versions of the original web content. In some embodiments, the cache 10 may also store client capability characteristics, being the set of information relating to the display characteristics of different client display device. Also provided is the content source 22, in which the original web content to be adapted is stored, and a content tidy module 18 which acts under the control of the content analysis module 20 to tidy up the original web content received from the content source store 22 prior to the analysis thereof. Furthermore, a customisation module 24 is also provided which is merely a front end system providing previews of the adapted web content from the content cache. The customisation module 24 is an offline module which allows the author to preview and further customise adapted content.

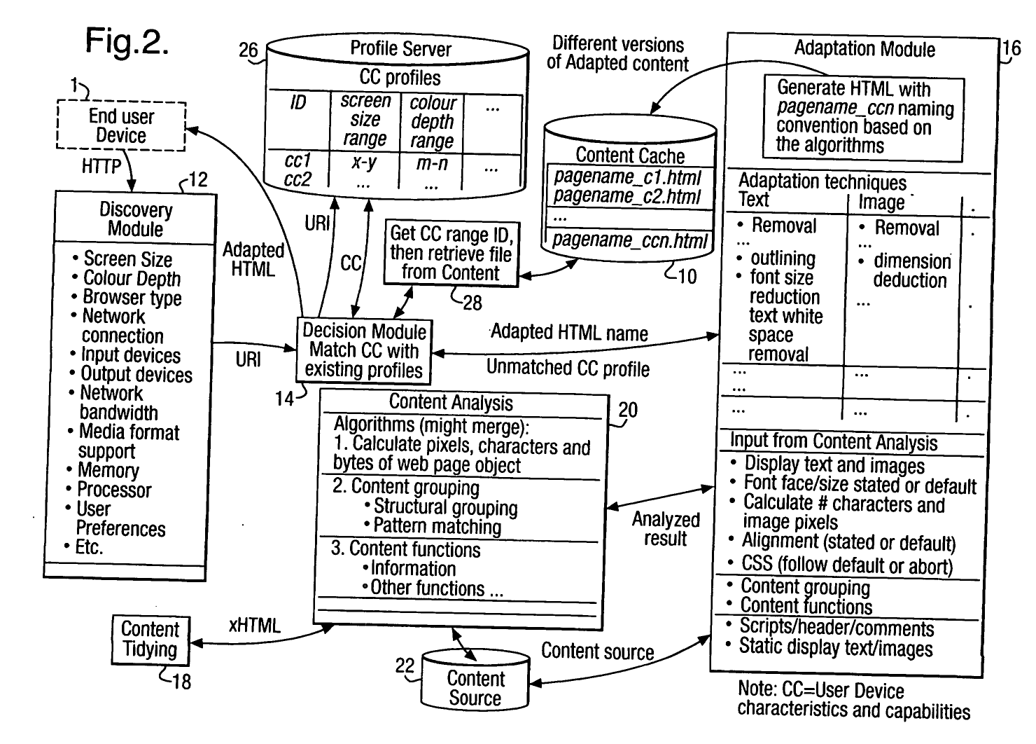

Having described the various system modules provided by the embodiment of the present invention, the operation of those modules will now be described in further detail with respect to FIGS. 2 to 5.

The system provided by the present invention would most likely be embodied in a computer system acting as a web server or the like. Alternatively, the system can be embodied in a computer system, or the components (as shown in FIG. 1) can be embodied in separate computer systems but one computer system acts as a web server to other computer systems. Howsoever the system is embodied, the computer system not only acts as a mere server, but also allows for the web content author to develop the web content and review it thereon. Moreover, the system also acts to generate different versions of the original web content for different intended display devices. In view of these functions, there are three distinct modes of operation of the system of the present invention: a first mode wherein it is acting to service user requests for web content, the request having been received over a network; a second mode wherein it acts to generate adapted versions of the web content for different intended display devices in advance of the receipt requests from users for such web content; and a third mode wherein adaptation of web content to provide a further adapted version can be performed on the fly in response to a user request. Each of these modes of operation will now be described.

Dealing with the second of the above described modes of operation first, imagine that the system of the invention is being used to generate different versions of original web content in advance of user requests therefor. For example, this mode could be used during website development to provide versions of an original source web content each especially adapted for different intended display devices, each with different display characteristics.

Therefore, when in this mode the first step to be performed is that a plurality of sets of predefined intended display device display characteristic profiles are created, each set having a unique ID, and corresponding to a set of one or more display characteristics, each characteristic taking a range of values. For example, a first client capability profile set could have fields entitled client_type screen_resolution, and colour_depth. A first profile ID CC1 would by way of example have the value “PC” in the client_type field, the value “800×600” or “1024×768” in the screen_resolution field, and “16bits” in the colour_depth field. As a further example, a further client profile set with the ID “CC2” could have the value “PDA” in the client_type field, the value “200×300” in the screen_resolution field, and the value “32bit” in the colour_depth field. It will be understood that the above are merely non limiting examples of the type of information which can contribute towards the profile sets and that a large number of different profiles can be easily created by forming a collection with different combinations of device characteristics and capabilities. Once created, the client capability profile sets are stored in a profile server 26, as shown in FIG. 2. This is merely a database system which acts to physically store the device profiles. The profile server 26 is accessible by the decision module 14 in order to allow the decision module to compare requesting user display device characteristics with the stored client capability profile sets.

Having created a plurality of client capability profile sets each with a different combination of intended display device characteristics and values, in the mode of operation presently described the system acts to then generate an adapted version of the original source web content for each of the client capability profile sets stored in the profile server 26. This is performed by triggering the adaptation module 16 to adapt the original source web content to match each client capability profile set. The adaptation module 16 will usually be triggered separately for each client capability profile set, such that on any one triggering, a single adapted version of the web content corresponding to a single client capability profile set will be generated. The detailed operation of the adaptation module 16 upon triggering is given below.

The first step performed by the Adaptation Module 16 is to trigger the Content Analysis module 20, by passing to it details of the original source web content to be adapted. The Content Analysis module 20 then retrieves the original content source from the Content source store 22 (which stores all the web content source created by developers/authors), and passes the retrieved content source to the Content Tidying module 18 for conversion to an xHTML file. The function of the Content Tidying module 18 is to tidy up the structure of the mark-up language (web content) and convert it into xHTML structure format. xHTML format provides a neat and tidy structure for the Content Analysis module 20 to perform the analysis task. The Content Tidying module 18 can be provided by using 3^{rd} party software such as TIDY, available at the priority date from http://tidy.sourceforge.net/. As such, no further details of the operation of the content tidying module 18 will be given here. The Content Tidying module 18 passes back the tidied xHTML file to the Content Analysis module 20.

Having received the tidied web content, the Content Analysis module 20 then performs the following tasks in sequential order:
i) calculates the total and individual pixels and characters of display objects in the web content;
ii) detects the functions of individual objects in the web content (normally they are the tags in a web page). For example, an object may possess a styling, structural or display tag;
iii) groups single objects based on their structural behaviour (information from object tag); and then
iv) matches the display object display patterns, and groups them together to form a group (performed using a Pattern Matching algorithm).

These four tasks are performed by respective dedicated algorithms, the details of which are given next.

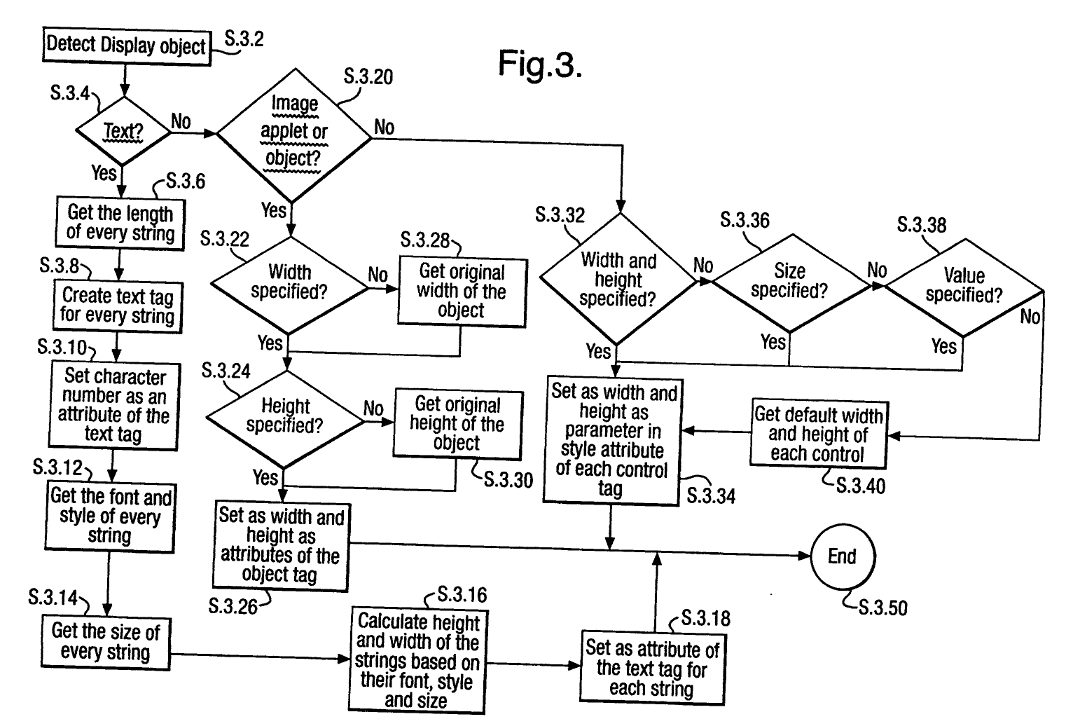

Concerning the first task, the purpose of this is to calculate the pixels/size of display objects such as text, image and etc. The algorithm which performs this task will first detect the type of display object. The algorithm then applies different analysis logic for different type of display objects. For example, if the display object is a text object, then it gets the length, font style and size and calculate the pixels based on these input. If the display object is an image/applet/object, then the algorithm will calculate total pixels based on width and height of the object. For the rest of the display objects, the algorithm will calculate total pixels based on the width, height and/or width/height attributes set in the parameter of the object (if it is specified in the HTML content). The exact steps performed by this algorithm are shown in FIG. 3, and described next.

Referring to FIG. 3, the first step to be performed by the algorithm at step 3.2 is that it detects an individual display object within the tidied web content. Then, at step 3.4 an evaluation is made to determine whether or not the detected display object is text. If this evaluation returns positive, such that the detected display object is determined to be text, then at step 3.6 the length of every text string within the display object is obtained. Next, at step 3.8 a text tag is created for every string, and at step 3.10 the numbers of characters in the string determined at step 3.6 is set as an attribute of the text tag.

Next, at step 3.12 the font and style of every text string is determined, and then at step 3.14 the size of every text string is also determined. Using this information, at step 3.16 the height and width of the text string based on their font, style, and size attributes is calculated and these calculated height and width values are set as further attributes of the text tag for each string at step 3.18. The process for that particular display object which was determined to be text then ends at step 3.50, and the process starts once again at step 3.2 to detect the next display object in the web content. Once all of the display objects have been processed by the algorithm, then the algorithm is not repeated.

Returning to step 3.4, if it is determined herein that the detected display object is not text, then a second evaluation is performed at step 3.20 to determine whether the detected display object is an image, applet, or object. If this evaluation returns positive, i.e. that the display object is an image, applet, or object, then processing proceeds to step 3.22 wherein a further evaluation is performed to determine whether or not the width of the image, applet, or object is specified. If this is the case then processing proceeds to step 3.24. If this is not the case, then processing proceeds to step 3.28, wherein the original width of the object is determined, and thereafter processing also proceeds to step 3.24.

At step 3.24 a further evaluation is performed to determine whether or not the height of the detected image, applet or object is specified. If this evaluation returns positive then processing proceeds to step 3.26. On the contrary, if the evaluation of step 3.24 returns a negative, then processing proceeds to step 3.30 wherein the original height of the object is determined. Processing then proceeds from step 3.30 to step 3.26.

At step 3.26, the width and height attributes of the image, applet, or object as determined by the previously described steps are set as the width and height attributes of the object tag within the web content. Following this, the processing of that particular display object then ends at step 3.50. As before, if further objects need to be processed then processing begins again at step 3.2.

Returning to step 3.20, if the evaluation performed therein determines that the detected display object is not an image, applet, or object, then processing proceeds to step 3.32, wherein an evaluation is performed as to whether the width and height of the detected display object are specified. If this is the case, then processing proceeds to step 3.34 wherein the specified width and height are set as parameters in the style attribute of each control tag for the detected display object. The processing then ends at step 3.50, and may be repeated if required as described previously.

If at step 3.32 it is instead determined that neither the width nor the height are specified, then processing proceeds to a further evaluation at step 3.36, wherein it is determined whether or not the size of the detected display object is specified. If this is the case, then processing proceeds to step 3.34 wherein the size is set as a parameter in the style attribute of each control type for the object. Again, processing then proceeds to step 3.50 where it ends, but may be repeated if there are further display objects to process.

Finally, if the evaluation at step 3.36 returns a negative, then a final evaluation at step 3.38 is performing to determine whether or not a value of a detected display object is specified and if so then the specified value is set as parameters in the style attribute of each control type for the object at step 3.34. On the contrary, if no such value is specified then processing proceeds to step 3.40 wherein a default width and height of each control is retrieved from memory, which are then set as default values at step 3.34.

This algorithm therefore acts to determine for each display object within the tidied web content size parameters such as the length of a text string, or the width and height of an image. This information may then be used in the adaptation process, to be described later.

Concerning the second task, a further algorithm is provided to perform this task, as described next.

First the algorithm to perform the second task pre-defines the function categories of single objects from a mark-up language perspective. A Single Object (O) is an element embedded in a mark-up language which carries properties of its own such as display styles, static or dynamic and structural styles.

We define the following pre-defined categories:

Information (I)

Information Title (T)

Control (C)

Decoration (D)

Replaceable Navigator (RN)

Un-replaceable Navigator (UN)

Replaceable Navigator Title (RNT)

Un-replaceable Navigator Title (UNT)

The definitions of these function categories are as follows:

Information (I)—an object that provides informative displayed content, which is important and cannot be replaceable. This object can be text, image, video, audio or any object (such as JAVA applet) file.

Information Title (T)—an object that describes the information object, which can be the text header or image with information properties.

Control (C)—an object that is meant for user interactive purposes, such as a button (radio or submit), input text area, form, drop down menu, check box, list box etc.

Decoration (D)—an object that does not play an informative role but is solely for improving the effect of visualization. This object can be image or text.

Replaceable Navigator (RN)—a Navigator is a URI link object. A Replaceable Navigator is a Navigator object that can be replaced by alternative text. It must be an image provided with alternative text.

Un-replaceable Navigator (UN)—as mentioned, a Navigator is a URI link object. An Un-replaceable Navigator is therefore a Navigator object that cannot be replaced by alternative text. It might be text or image without alternative text.

Replaceable Navigator Title (RNT)—A replaceable navigator title is the informative URI link object which describes a Navigator object. It can be replaced by alternative text. It must be an image provided with alternative text.

Un-replaceable Navigator Title (UNT)—This is an informative URI link object which describes a Navigator object. It cannot be replaced by alternative text. It might be text or image without alternative text.

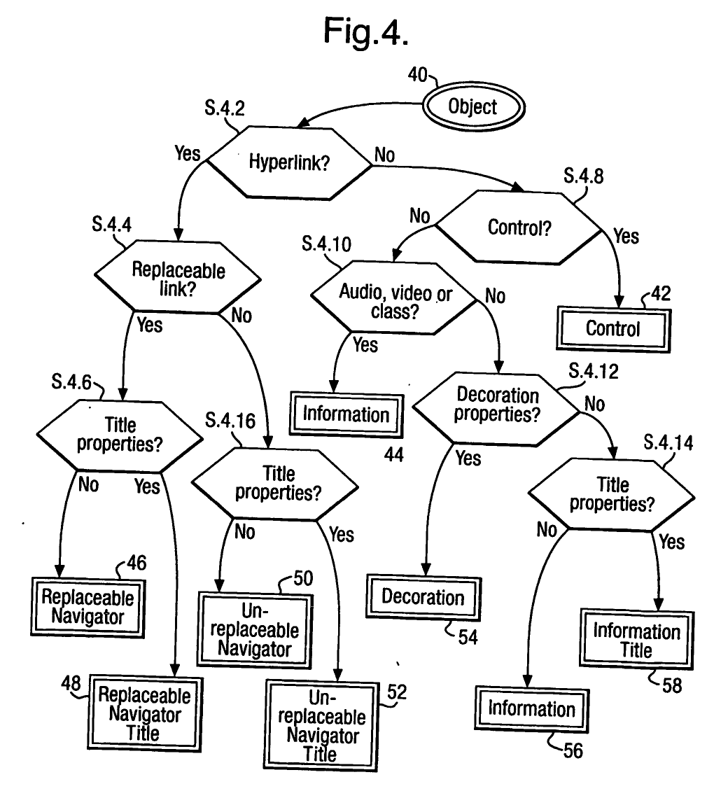

By providing such pre-defined function categories, the algorithm starts a scanning and comparing mechanism that analyses the properties of single objects embedded in a mark-up language (such as HTML). The reasoning of the analysis is based on a decision tree (scanning and comparison logic sequence), as shown in FIG. 4.

The algorithm begins by scanning the web content mark-up language from top to bottom. When the scanning process starts, every single object of the mark-up language is searched, detected and compared with the pre-defined function categories. This comparing process is carried out until end of the mark-up language.

Within the scanning loop, the algorithm searches for single objects and determines their function based on the properties carried by the object. The algorithm stops comparing the single object (Oₙ) properties and searches for the next single object (Oₙ₊₁) after the first single object On has qualified for a particular function category.

Referring to FIG. 4, the decision tree process applied by the algorithm is as follows. The algorithm starts by first searching for a single object. Once a single object 40 has been detected, the algorithm then checks at step 4.2 as to whether the detected object has hyperlink properties embedded therein. If the object has hyperlink properties, then a check is performed at step 4.4 to determine if the object is replaceable by finding whether there is any alternative text for the object. If there is alternative text and title properties for this object (as determined by step 4.6), then this object is categorised as a Replaceable Navigator Title (RNT) 48. Else if there is alternative text but no title properties for this object, then the algorithm categorises this object as a Replaceable Navigator (RN) 46.

If there is no alternative text and title properties for this object, then the algorithm categorises this object as an Un-replaceable Navigator Title (UNT) 52. Else if there is no alternative text and no title properties for this object, then the algorithm categorises this object as an Un-replaceable Navigator (URN) 50. This distinction is evaluated at step 4.16. The title properties of RNT and UNT are based on the following conditions:

It has title header properties; and

It is a display object; and

It must be URI hyperlink (image or text); and

It has different styles compared to its adjacent display object.

After comparing the object with the hyperlink properties at step 4.2, 4.4, 4.6, and 4.16, if the object has not yet been categorised the invention will route the checking logic for non-hyperlink properties. User side interaction properties are the next to be compared. The factors that determine if the single object has user side interaction properties are if the single object is one of the following: button (radio or submit), input text area, form, drop down menu, check box, or list box, and an evaluation to this effect is made at step 4.8

If the single object is detected at step 4.8 as having user side interaction properties, it will be categorized as a Control (C) 42. Else, the algorithm will further compare if it is an object which carries video, class object or audio properties, at step 4.10. If it is, then this single object will be included in the Information (I) function category 44.

If the object has still not been categorised, the algorithm further checks the single object by determining if there are decoration properties carried by the single object at step 4.12. The decoration properties are determined based on the following criteria:

The size of the single object—The size of the single object is derived from an experimental value which best represents the size of decoration properties; or

The presence of symbols, lines and separators between the present single object (Oₙ) and the next single object (Oₙ₊₁).

The object size (width & height) is based on experimental value (subjective value). The inventors performed experimental tests on 100 web pages, and our results showed that images with pixel sizes width <=20 and height <=20 tended to be a decoration object.

If the present single object qualifies from the above conditions, it will be categorized as a Decoration (D) function 54. If there are no decoration properties found within the single object, the invention will further check for information title properties, at step 4.14.

Once the single object is determined as not having decoration properties, it will be either categorized as Information function or Information Title function at step 4.14. The single object will only be qualified as Information Title (IT) 58 based on the following criteria:

It has title header properties; and

It is a display object; and

It might be text or image only; and

It has different styles compare to its adjacent display object.

If the single object is determined not to have the title properties, it will be categorized as an Information (I) function 56.

Therefore, as will be apparent from the above, based on the scanning process and comparing mechanism done by this algorithm, all of the single objects in the tidied web content obtain an assigned specific function to represent their role within the mark-up language, thus fulfilling the second task performed by the content analysis module 20.

Regarding the third task, a further algorithm is provided within the content analysis module to perform this task. The main purpose of this third algorithm is to group content into clusters based on their positioning information. Structural tags represent this information. The structural tags we recognize and select are:

<TABLE>, <FORM>, <FRAMESET>, <DIV>, <UL>, <OL>, <DL>,
<P>, <PRE>,
<ADDRESS>, <BLOCKQUOTE>, <Hn>, <HR>, <CENTER>,
<MENU>, <DIR>,
<TD> and <NOSCRIPT>;

which were selected for clustering objects because they are able to group objects together visually when the objects are displayed on client browsers.

The operation of the algorithm which performs this task is simple, and merely acts to parse the web content and select objects for grouping on the basis of the presence of any of the above tags within the object.

With respect to the fourth task, i.e. that of matching the display object display patterns, and grouping them together to form a group, a pattern matching algorithm is provided, as described next.

Web pages can be thought of as comprising of a number of content chunks. These chunks are sets of multimedia objects that relate to particular areas of interest or tasks. If a basic object is defined as one that contains a single multimedia element (for example an image or a body of text), and a composite object is defined as a set of objects (basic or composite) that perform some certain functions together, then a chunk is itself a high-level composite object. When a web-page is split up into a number of smaller pages it is important for the intelligibility that the content chunks are not broken up. Thus, before adapting the content, the multimedia objects that make up the page need to be grouped into potential chunks.

Yang and Zhang of Microsoft Research have described a system for locating such content chunks, in Yang, Y. and Zhang, H. J. “HTML Page Analysis Based on Visual Cues” In 6^{th} International Conference on Document Analysis and Recognition (ICDAR2001), 2001. The following paragraphs outline a similar system. Both systems use the HTML tags to perform an initial grouping of multimedia objects into possible composite objects, followed by application of pattern matching to find possible further groupings. The difference between the systems lies in the distance measure used to determine the similarity of various objects and the algorithm for pattern matching.

Initial Grouping of Objects

Before performing the initial grouping of multimedia objects into possible composite objects, the HTML document is parsed into an xHTML tree to clean up the HTML tags and to form an easy to manipulate structure. The xHTML tree consists of HTML tags at the nodes and multimedia objects at the leaves.

The next step involves the construction of a group tree, in which the leaves contain multimedia objects and nodes denote composite objects (and so potential content chunks), up to the top node which denotes the entire web-page. The xHTML tree is transformed into a group tree, by first inserting <g> tags directly above i) the leaves in the tree and ii) tags belonging to a predefined set of HTML tags associated with the natural breaks in the content, mainly block level tags, such as <table>, <td>, <form>, <center> and <h>. Second, a set of tokens, one for each type of multimedia object is defined along with sets of attributes, for example, the number of characters in the text string, or the width and height of the image. Third, working from the multimedia objects at the leaves in the tree, the tokens are passed upwards and all nodes other than the leaf and those containing <g> tags are removed. As a token is passed upwards it accumulates attributes associated with the nodes, if a node has more than one child then all the children receive the attribute associated with it. Some formatting tags, such as <tr>, are ignored since they to not impose any attributes onto the multimedia elements and unlike the tags in the predefined set are not usually indicative of a new content chunk. If a <g> tag node has more than one child then the tokens arranged in a linear list in the same left-to-right order in which the child nodes are arranged.

By labelling the objects associated with various block-level tags, such as tables and cells, as potential groups; the group tree already incorporates the majority of the composite objects and so content chunks. This technique assumes, not always correctly, that the <g> tags do not split any content chunks. However, labelling the contents of formatting objects does not distinguish between content chunks which are implied through repeated arrangements of similar multimedia objects. Thus, once the group tree has been derived, pattern matching is performed on the list of tokens belonging to the child nodes of each <g> node.

Pattern Matching

The first step in the pattern matching process is determining which of the lists of tokens in each of the child nodes are similar. Note that each token has a set of attributes associated with it. Each attribute consists of a type and a value pair, for example (font, 14pt) and (width, 100). The values can either be strings or integers. If an attribute type does not naturally have a value associated with it then the value is set to a null string, for example (bold, ). When comparing tokens, if a particular token does not have any attributes associated with it, then it is assigned a special null attribute (,) to ensure that the set of attributes is not empty.

To compare two tokens, α and β, with the sets of attributes: (Tᵢ^{α}, Vᵢ^{α}), i=1, . . . ,N^{α} and (Tⱼ^{β}, Vⱼ^{β}), j=1, . . . , N^{β} the following similarity measure is used

$$S ( α , β ) = ( {\sum }_{i = 1}^{{N}^{α}} ( {T}_{i}^{α} , {V}_{i}^{α} ) \cdot ( {T}^{β} , {V}^{β} ) + {\sum }_{j = 1}^{{N}^{β}} ( {T}_{j}^{β} , {V}_{j}^{β} ) \cdot ( {T}^{α} , {V}^{α} ) ) / ( {N}^{α} + {N}^{β} )$$

where i) (Tᵢ^{α}, Vᵢ^{α})(T^{β}, V^{β})=1 if ∃ 1≦j≦N^{β} such that Tᵢ^{α}=Tⱼ^{β} and Vᵢ^{α}=Vⱼ^{β}
ii)(Tᵢ^{α}, Vᵢ^{α})(T^{β}, V^{β})=min(Vᵢ^{α}, Vⱼ^{β})/max(Vᵢ^{α}, Vⱼ^{β}) if ∃ 1≦j≦N^{β} such that Tᵢ^{α}=Tⱼ^{β} and both of Vᵢ^{α} and Vⱼ^{β} are integers
iii) (Tᵢ^{α}, Vᵢ^{α})(T^{β}, V^{β})=0 otherwise.

Comparison of lists of tokens is achieved by dynamic time warping (a dynamic programming algorithm), see table 1 below, in which the alignment path is not allowed to wander more than a given number (proportional to the length of the smallest token) places off the diagonal and also incorporates a punishment for non-diagonal movements.

If the sum of the similarity measures along the alignment path is greater than a threshold the two lists of tokens are regarded as similar since they are either identical or if there is only a little variation in their length and composition.

TABLE 1
JAVA code for the comparison of lists of tokens.

Public boolean Compare(ArrayList A, ArrayList B)
{
float M[][] = new float[A.size( )+1][B.size( )+1];
float Allow = 0.55 // acceptable average gain per token
float P = 0.3; // punishment for non-diagonal transitions
for (x=1;x<=A.size( );x++)

{
for (y=1;y<=B.size( );y++)

{
if ((x−y)<=2 && (x−y)>=−2) // if with 2 of diagonal

M[x][y] = Max(M[x−1][y−1],M[x−1][y]−P,M[x][y−1]−P)

+ S(A.get(x−1),B.get(y−1));
}

}

if (M[A.size( )][B.size( )]>Min(A.size( ),B.size( ))* Allow)

return true;

else return false;
}

To detect patterns, a lower triangular matrix, minus the diagonal elements, is first constructed detailing which of the child nodes (lists of tokens) are similar to one another. Next the significant token pattern, that is the repeated sequence of similar nodes that covers the largest number of child nodes, is found by examining all possible patterns. The significant token pattern denotes the start of each new group. To prevent trivial significant token patterns emerging a number of constraints are applied, namely:

The pattern must be at least two child nodes in length; and

The pattern must be repeated at least twice; and

Instances of the same pattern should not overlap.

As these significant tokens denote the start of the groups (or content chunks), the groups are themselves extended by adding the following child-nodes into the groups whilst ensuring non-overlapping and reasonable similarity amongst the groups.

The above concludes the four tasks performed by the content analysis module 20. After the tasks, the Content Analysis module 20 has formed groups which should be ready to be passed to Adaptation Module. The information provided by the grouping tasks performed by the content analysis module 20 and passed to the adaptation module 16 relate to:

i) Unbreakable groups which are not supposes to be separated after adaptation (i.e. the “chunks” referred to above);

ii) the functions of groups and single objects, which indicate whether they can be ignored or removed;

iii) the total display pixels and characters of the content source, which is used by the Adaptation module to decide whether to split the content into pages; and
iv) The original structural and styling information of the content source. Here, structure means the layout of content. Structural information contains codes of how the content is arranged and positioned. Style means content objects' (such as text or image) width, height, colour, font attributes (e.g. font-face and size), etc.

As mentioned, the Content Analysis module 20 passes the results of the analysis to the Adaptation module 16. The Adaptation module 16 then retrieves all the client capability device profiles available (and which in this mode of operation were pre-generated) from the Profile Server 26. The Adaptation module 16 then triggers loops which run an algorithm to generate different versions of web content based on the profiles available. The number of loops performed will depend on the number of profiles available. Essentially, an adapted version of the content is generated for each client capability profile.

The main purpose of the adaptation algorithm is to check if the whole content can be fit into a client device. If the whole content cannot be fit, then a series of transformations will be performed by the algorithm. Therefore, the algorithm performs the following checks in order:

i) Check if the total pixels and characters of the source content can be fit into the profile range;

ii) Check if after removing the blank spaces and lines, content source can be fit into the profile range; and

iii) Check if removing, resizing, summarizing, and changing properties of the display object will fit the source content into the profile.

These checks are embodied by 8 possible transformations which may be applied to the analysed original web content. These transformations are applied in order, but after each transform has been applied an evaluation is performed to determined if the whole original content as transformed up to that point can be displayed on the intended device, by referring to the client capability profile for that device. If it is determined that display is possible then no further transformations are applied, otherwise all 8 transformations are applied.

The available transformations, in order, are as follows:
1^{st} transformation: Font reduction. Here the original font is transformed into a smaller font size with “verdana” as the font-family.
2^{nd} transformation: Image reduction. The purpose is to reduce image objects by 10% and goes into recursion until it reaches the optimum size or 50%.
3^{rd} transformation: Control object reduction. The purpose is to reduce objects based on the ratio of default screen size and client device if the result is greater than an optimum size of the object.
4^{th} transformation: Space removal. The purpose is to get rid of those unnecessary space between paragraphs.
5^{th} transformation: Line removal. Its purpose is the same as the 4^{th} transformation.
6^{th} transformation. Decoration image removal. The purpose is to remove images which have decoration properties based on objects' size.
7^{th} transformation: Decoration text removal. The purpose is to remove redundant texts which act as decoration if they are special characters.
8^{th} transformation: Image replacement. If there is an alternate text for an image, then the algorithm will compare the alternate text size with the image itself. The shorter will be selected as the adapted result.

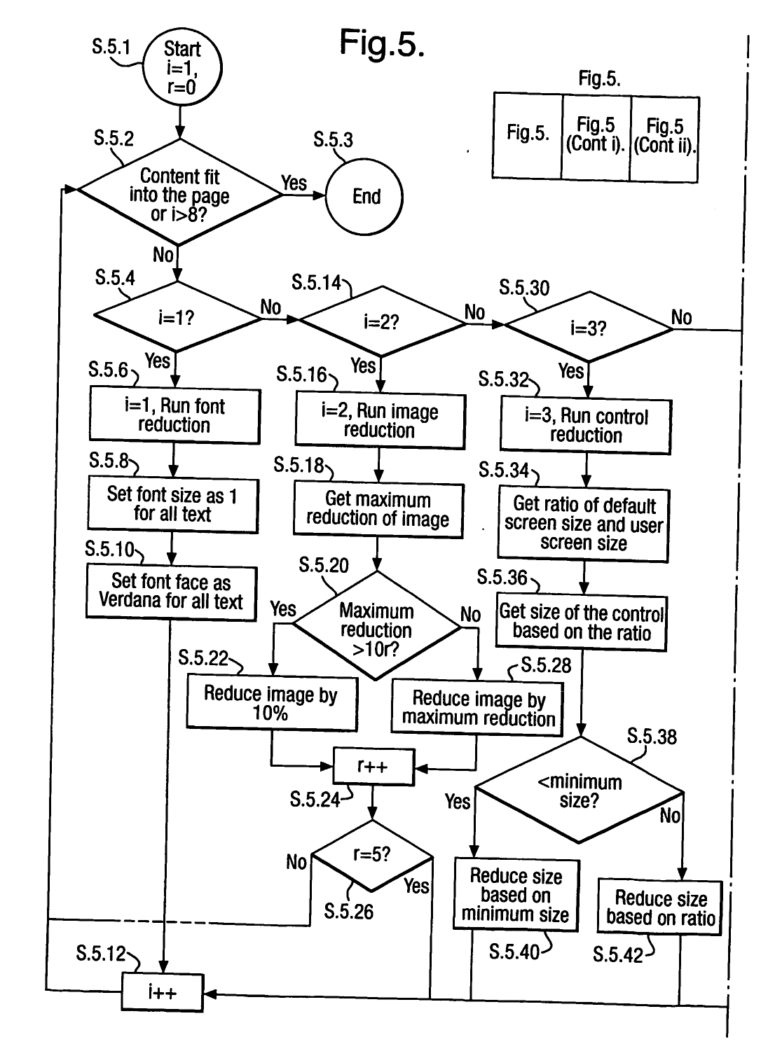

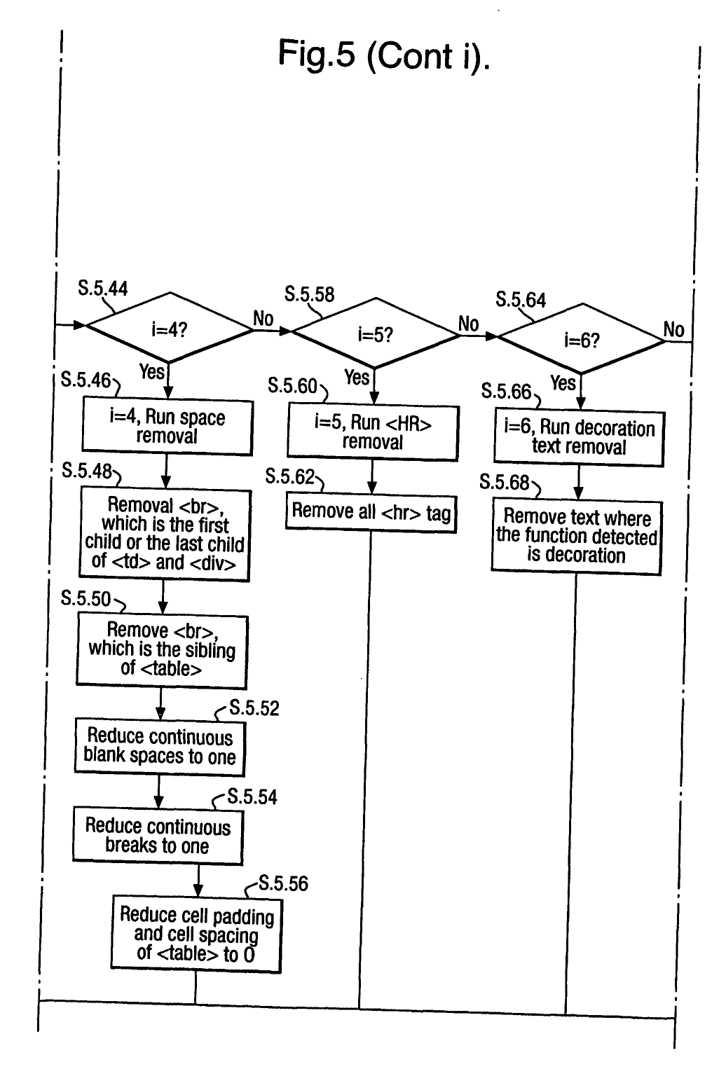

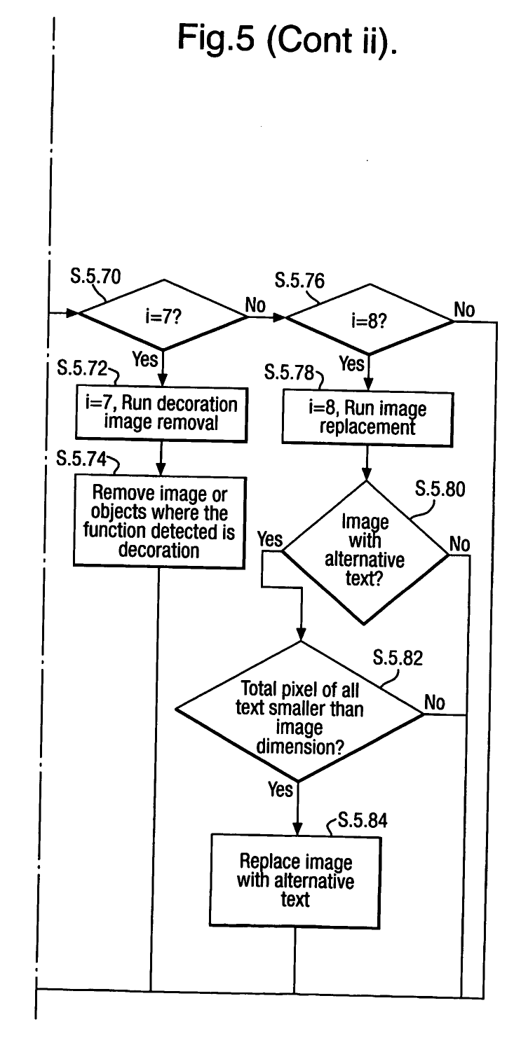

FIG. 5 illustrates the adaptation algorithm in more detail, and in particular illustrates the eight different transforms which may be applied. Referring to FIG. 5, the procedure provided thereby is started at step 5.1 wherein two counters are initialised. More particularly, a first counter i is initialised to i=1, and a second counter r is initialised to r=0.

Next, processing proceeds to step 5.2, wherein an evaluation is performed to determine whether or not the analysed web content will fit into the display of the intended display device. This evaluation is performed by comparing the characteristics of the contents with the client device display capability characteristics as provided in the client capability profiles in the profile server 26. To generate a particular adapted version, at step 5.2 the evaluation is always performed against a single one of the client capability profiles, in respect of which an adapted version is being generated by the present instantiation of the adaptation algorithm.

If the evaluation at step 5.2 indicates that the existing web content can fit into the display of the intended display device, and no adaptation is required, and the adaptation algorithm ends at step 5.3.

On the contrary, if the evaluation at step 5.2 returns a negative, then processing proceeds to step 5.4 wherein an evaluation is performed to determine as to whether the counter i=1. It will be recalled here that when the algorithm is first started at step 5.1 the counter I is initialised to one, and hence the evaluation at step 5.4 returns a positive, and processing proceeds to step 5.6. Here, the first transformation in the form of font reduction is started, which takes the forms of steps 5.8 and 5.10.

At step 5.8 the font size for all text in the web content to be adapted is set as 1, although in other embodiment other values may be chosen. Next, at step 5.10 the font typeface for all text in the web content is set as “verdana”. These steps have the result of drastically reducing the size of any text objects in the web content. Following the steps processing proceeds to step 5.12, wherein the counter i is incremented by one, and then processing proceeds back to the evaluation at step 5.2 wherein an evaluation is performed to determine whether or not the transformed web content will now fit into the display of the intended display device. If this evaluation at step 5.2 returns a positive, i.e. the web content is now capable of being displayed on the intended display device, then the process proceeds to step 5.3 and ends. On the contrary, if further transformations are required then processing proceeds to step 5.4, wherein an evaluation is made as to whether the counter i is equal to one. Here, as the count i was incremented at step 5.12 and is now equal to two, a negative result is returned and hence processing proceeds to the evaluation at step 5.14, which evaluates whether the counter i is equal to two. Here a positive value will be returned, whereupon processing will proceed to step 5.16.

At step 5.16 an image reduction transformation is commenced. Within the image reduction transformation, first at step 5.18 a maximum possible reduction of the image is obtained. This is a hard coded value, for example 50%. Next, at step 5.20 an evaluation is made as to whether or not the maximum reduction value is greater than ten times the value of the counter r. It will be recalled here that at step 5.1 the value of the counter r was initialised at to zero, and hence on the first recursion the evaluation of step 5.20 will return a positive value. Here processing proceeds to step 5.22, wherein images within the web content are reduced by 10%. Processing then proceeds to step 5.24 wherein the counter r is incremented by one, and from there to step 5.26 wherein an evaluation is made as to whether or not r is equal to 5. On the first recursion r will have been incremented at step 5.24 to take the value 1 only, and hence the evaluation of step 5.26 will return a negative value. In this case processing proceeds directly back to step 5.2, wherein the evaluation as to whether or not the transformed content will fit into the display of the intended display device is undertaken. If this is the case then processing ends at step 5.3 although if it is not the case then processing proceeds via step 5.4 to step 5.14, wherein, because i has not yet been incremented again, a positive evaluation is returned, and the image reduction transformation of steps 5.18, 5.20, 5.22, 5.24 and 5.26 is applied once again.

It will be seen from FIG. 5 that the image reduction transformation can be applied up to five times, and each time it is applied the images are further reduced in size by 10% for each recursion, or by the maximum reduction value available, in the event that the maximum reduction available of the image is not greater than ten times the present value of r. In either event, however, the transformation is recursively applied five times, until the counter r=5. In this case, the evaluation of step 5.6 will then return a positive, whereupon processing will proceed to step 5.12, wherein the counter i is incremented. From step 5.12 processing always proceeds back to step 5.2, wherein the evaluation as to whether or not the content will now fit into the display of the intended display device is undertaken. If the transformations already applied are sufficient, then this evaluation will return a positive value and processing will end at step 5.3. If the transformations already applied are not sufficient, however, and further transformations are required, then processing will proceed via step 5.4 and now also via step 5.15 (by virtue of i now being equal to 3) to step 5.30.

Here, an evaluation is made as to whether or not the counter i equals 3, and if so processing proceeds to step 5.32, wherein the control object reduction transformation is commenced by proceeding to step 5.34.

At step 5.34 a ratio is obtained of the default screen size for the web content, and the actual screen size of the intended display device. Based on this ratio, at step 5.36 a size of each control object is calculated based on the ratio, by applying the ratio to the default size. Then, at step 5.38 an evaluation is performed at to whether or not the calculated size for each control object is less than the minimum allowable size for each object, and if not processing proceeds to step 5.42 wherein the control object sizes can be reduced based on the calculated ratio. If, however, the calculated size is less than the allowable minimum size of each control object, then processing proceeds to step 5.40, wherein the size of the control objects in the web content is reduced based on the allowable minimum size. The allowable minimum size is predetermined in advance.

After either step 5.40 or step 5.42, processing proceeds to step 5.12 wherein the counter i is incremented, and thereafter to step 5.2 wherein the evaluation as to whether or not the transformed content will now fit into the display of the intended display device is performed.

Assuming the evaluation of step 5.2 returns a negative, the counter i is now equal to the value 4, and hence processing proceeds via step 5.4, step 5.14, and step 5.30, to step 5.44 wherein the evaluation that i equals 4 returns a positive value. This has the result of causing processing to proceed to step 5.46, wherein the space removal transformation is commenced.

This transformation relates to looking at object tags within the web content, and removing those objects which have particular tags and/or which meet other certain conditions. Therefore, at step 5.48, those objects which have tag <BR> and which are the first child and the last child of objects with tags <TD> and <DIV> are removed. Next, at step 5.50, those objects with tag <BR> and which are the sibling of objects with tag <Table> are also removed, and then, at step 5.52 any continuous blank spaces within the web content display objects are reduced to a single space, and correspondingly, at step 5.54 any continuous breaks within the web content display objects are reduced to one. Finally, at step 5.56 the cell padding, and cell spacing values of any <table> objects are reduced to zero. The result of the space removal transformation is to reduce blank space in the web content to an absolute minimum.

Following step 5.56 processing proceeds to step 5.12, wherein the counter i is incremented to 5. The evaluation at step 5.2 is then performed to determine whether or not the transformed content will now fit into the display of the intended display device, and if so processing then ends at step 5.3. If not, however, processing would proceed via step 5.4, step 5.14, step 5.30 and step 5.44, to step 5.58, wherein the evaluation that i is equal to 5 would return a positive. Thereafter at step 5.60 the line removal transformation is applied, which acts at step 5.62 to remove all display objects with a <HR> tag. This has essentially the same function as the fourth transformation previously applied, i.e. to reduce blank space.

After step 5.62, processing proceeds to step 5.12 once again, wherein the counter i is incremented. The evaluation of step 5.2 is then performed once again, and assuming that it produces a negative result processing will proceed to step 5.64 via steps 5.4, 5.14, 5.30, 5.44, and 5.58. The evaluation at step 5.64 will result in a positive result, as i has been incremented to 6.

Therefore, following step 5.64 processing proceeds to step 5.66, wherein the decoration text removal transformation is commenced. This is performed at step 5.68, wherein text which had its function detected by the content analysis module 20 as being for decorative purposes is removed from the web content.

Following step 5.68 processing proceeds to step 5.12 wherein the counter i is incremented, and thereafter to the evaluation at step 5.2 as to whether or not the transformed content will now fit into the display of the intended display device. Assuming this is not the case, processing proceeds by the respective evaluations of steps 5.4, 5.14, 5.30, 5.44, 5.58, and 5.64 to step 5.70, and therein as the counter i now has a value of 7 a positive result is returned. This causes processing to proceed to step 5.72, wherein the decoration image removal transformation is commenced. At step 5.74 those images or objects whose function was detected by the content analysis module 20 as been decoration are removed. Thus images which do not contribute to the real semantic content of the web content are removed.

Following step 5.74, processing proceeds once again to step 5.12 wherein the counter i is incremented. Thereafter the evaluation at step 5.2 is performed as to whether or not the now transformed content will fit into the display of the intended display device, and assuming that this evaluation returns a negative value, processing proceeds via the respective evaluations of step 5.4, step 5.14, step 5.30, step 5.44, step 5.58, step 5.64, and step 5.70 to step 5.76, wherein an evaluation is performed as to whether i is now equal to 8. As this evaluation will return a positive result, processing proceeds to step 5.78 wherein the image replacement transformation is commenced. This starts at step 5.80, wherein, for each image display object an evaluation is performed as to whether or not the image has alternative text. If this is the case, then processing proceeds to step 5.82 wherein a further evaluation is performed as to whether or not the total pixel size of the alternative text to the image is smaller than the image itself. Only if this is the case will the image be replaced with the alternative text. There is clearly little point in replacing an image with alternative text, if that text will take up more space than the image. Following the replacement at step 5.84 processing proceeds to step 5.12. Similarly, if either of the evaluations of step 5.80 or step 5.82 return a negative value i.e. an image does not have alternative text, or the alternative text is not smaller than the existing image size, then processing similarly proceeds to 5.12. It should be pointed out here that the image transformation depicted in FIG. 5 is applied to each image in turn, before processing proceeds to step 5.12 and the counter i is incremented. Moreover, this processing of multiple objects in the web content applies to each of the transformations previously described, in that each transformation is applied to every relevant object in the web content before the counter i allowing the next transformation to be applied is incremented.

At step 5.12, once again the counter i is incremented, such that in this case it now takes the value 9. Therefore, when processing proceeds to the evaluation at step 5.2, the alternative condition of that evaluation that i is greater than 8 is now met, and hence the adaptation algorithm must therefore end.

It will therefore be seen from the above description that the adaptation algorithm acts to apply each transformation to the display objects in the web content in turn, and evaluate after the application of each transformation as to whether or not the transformed web content is capable of being displayed on the display of the intended display device. If this is the case then no further transformations are applied.

Moreover, the adaptation algorithm will also split the content source and re-structuring/style-tailoring it into the optimum numbers based on the grouping information passed by Content Analysis module, which means unbreakable group will be in the same page and breakable groups might be separated in different pages in form of mark-up language such as HTML with CSS or XML with XSL.

After the adaptation process is done, a different version of web content will have been generated for a particular client capability profile. As there are a plurality of client capability profiles, however, the adaptation algorithm must be run repeatedly to generate an adapted web content version for each client capability profile. Following this (i.e. after all the versions have been created) the Adaptation module creates the profile Ids for the versions created based on the client capability profiles, and stores the adapted versions and Ids in the Content Cache. The logical relationship of the profile ids and physical adapted content is in the form of a database structure cross reference link. These versions of adapted content are then ready to be retrieved and delivered to an end user upon request.

Thus, in the above described mode of operation, the system according to the embodiment of the invention acts to generate multiple adapted versions of the original web content in advance of user requests therefor, each version being for a particular intended display device with known and specified characteristics.

As mentioned previously, however, the system according to the embodiment of the invention may also operate in a web server capacity. This mode of operation will be described next.

Imagine that the system according to the embodiment of the invention is acting as a web server and is connected to the Internet. The server receives an http request for web content from an end user device 1. Within the embodiment of the invention, that http request is first routed to the client capability discovery module 12, which acts to determine the set of display characteristics of the end user device 1, such as, for example screen size, colour depth, browser type, network connection, etc.

The client capability discovery module detects device capabilities based on existing standards such as those put forward by M3I (please refer to Current Technologies for Device Independent, Mark H Butler, HP Labs Technical Report HPL-2001-83 4 Apr. 2001, referenced previously, the relevant contents of which necessary for a full understanding of the present invention being incorporated herein by reference). At the present time most internet browsers contain end-users' device information such as browser type and version, IP address, screen resolution etc in the initial request sent to the web server. An end-user's device will start communicating with the server when the end-user enters a URL through a web browser. To get the end-user device information, client capability discovery module 12 uses a simple Javascript™ to retrieve the client capability information sent from the end-user's browser and passes the information to the server through a Java servlet program. There follows below a sample of the Javascript™ program which get and post end-user device information to the server through a Java® Servlet called “clientprofile”:

<script language=“JavaScript”>
function getdeviceinfo( ) {

| | |
|---|---|
| document.formclient.pageUpdate.value | = |

document.lastModified ;

| document.formclient.availHeight.value = screen.availHeight; | |
|---|---|
| document.formclient.availWidth.value = screen.availWidth; | |
| document.formclient.bufferDepth.value = screen.bufferDepth; | |
| document.formclient.colorDepth.value = screen.colorDepth; | |
| document.formclient.fontSmoothingEnabled.value | = |

screen.fontSmoothingEnabled;

| document.formclient.height.value = screen.height; | |
|---|---|
| document.formclient.width.value = screen.width; | |
| document.formclient.updateInterval.value | = |

screen.updateInterval;

| | |
|---|---|
| document.formclient.javaEnabled.value | = |

navigator.javaEnabled( );

| document.formclient.appName.value= navigator.appName; | |
|---|---|
| document.formclient.appVersion.value | = |

navigator.appVersion;

| | |
|---|---|
| document.formclient.cookieEnabled.value | = |

navigator.cookieEnabled ;

| document.formclient.cpuClass.value = navigator.cpuClass ; | |
|---|---|
| document.formclient.mimeTypes.value = navigator.mimeTypes ; | |
| document.formclient.appCodeName.value | = |

navigator.appCodeName ;

document.formclient.platform.value = navigator.platform ;
document.formclient.opsProfile.value = navigator.opsProfile

;

| document.formclient.plugins.value = navigator.plugins ; | |
|---|---|
| document.formclient.systemLanguage.value | = |

navigator.systemLanguage ;

| document.formclient.userAgent.value = navigator.userAgent ; | |
|---|---|
| document.formclient.userLanguage.value | = |

navigator.userLanguage ;

| | |
|---|---|
| document.formclient.userProfile.value | = |

navigator.userProfile ;

document.formclient.action= “clientprofile”;
document.formclient.submit( );

}
</script>

Having determined the set of client characteristics of the end user device 1, the client capability discovery module 12 then passes the set of characteristics determined thereby to the decision module 14, which acts to compare the end user device characteristics with the set of client capability profiles stored in the profile server 26. If the decision module 14 can match the set of end user device characteristics with one of the client capability profiles, then the decision module accesses the content cache 10 which stores the different versions of adapted content using the profile ID of the client capability profile which matched to the end user device characteristics as an index thereto. The adapted version of the web content which is indexed to the profile ID of the matching client capability profile is then retrieved from the content cache 10, and supplied via the network to the end user device 1. Thus, in this mode of operation, the system according to the embodiment of the invention is able to match end user device display characteristics with a set of predefined device characteristics, so as to determine the appropriate pregenerated adapted version of the web content to send to the end user device.

As previously mentioned above, the system provided by the embodiment of the invention also provides a further mode of operation, which combines the operations provided by the previously described modes. Here, when an end user device 1 makes a request for web content, as before the client capability discovery module 12 acts to determine the display characteristics thereof, which are then passed to the decision module 14. The decision module 14 then attempts to match the capabilities of the end user device 1 with the client capability stored in the profile server 26, and if a match is found then the appropriate adapted version of the web content is retrieved from the content cache 10, and passed to the end user device 1 over the network. If, however, no match can be made, then the decision module 14 acts to operate the adaptation module 16, by passing the details of the end user device 1 relating to the characteristics as determined by the client capability discovery module 12 to the adaptation module 16. The adaptation module 16 then creates a new client capability profile which is stored in the profile server 26 corresponding to the capabilities of the end user device 1, and also starts its operation in exactly the same manner as previously described when pre-generating adapted versions of the web content, so as to create a new adapted version of the web content adapted specifically for the end user device 1. That is, the adaptation module 16 causes the content analysis module 20 to operate, which analyses the web content, allowing the adaptation module to run the adaptation algorithm so as to generate a new adapted version of the web content specifically for the end user device 1. The adapted web content is then fed back to the decision module, which forwards it over the network to the end user device 1. In addition the new adapted web content is also stored in the content cache 10 for future use by similar end user devices to the end user device 1, if required. Therefore, in this further mode, new versions of adapted web content can be created dynamically in response to a user request but are also then stored so as to be used to service future user requests if required.

In addition to the modes of operation described above, the system according to the embodiment of the invention also provides the customisation module 24. This is merely a front end to allow web authors to browse the various adapted versions of the web content stored in the content cache, so as to make further refinements or improvements thereto if required. In view of this functionality, no further discussion of the customisation module 24 will be undertaken.

In conclusion, therefore, the present invention provides a system which allows for different versions of web content to be created in advance of user requests therefor, such that user requests can then be serviced by matching the display characteristics of the end user device to the precreated versions, and hence allowing a response to be generated quickly, and with very little computing intensity. Additionally, if required, new versions of adapted web content can be dynamically created to match a specific end user device requesting the web content, and the dynamically created adapted web content is then also stored for later use in servicing future requests from similar end user devices.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. An apparatus for providing web page content to a display device, the apparatus comprising:
a content store arranged to store a plurality of different versions of the same web page content, each version being adapted for display on an intended display device having a set of one or more defined display characteristics;
means for receiving requests for web page content from display devices;
display device characteristic determining means arranged to determine the one or more display characteristics of a display device from which a request for web content is received;
content version selection means arranged to select a version of the web content stored in the content store in dependence on the determined display characteristics of the display device from which a request for web content was received, the selected version being that which is adapted for display on display devices having the determined display characteristics; and
means for transmitting the selected version to the display device.

2. An apparatus according to claim 1, and further comprising adaptation means arranged to adapt said web page content in dependence on the determined display characteristics of the display device from which a request for web content is received so as to provide a version of the web page content adapted for display on the such device, said adaptation means being operable in the event that the content version selection means determines there is no version in the content store which is adapted for display on the device having the determined display characteristics.

3. An apparatus according to claim 2 wherein said adaptation means further comprises:
i) web page content analysis means for analysing the web page content to determine one or more characteristics thereof;
said adaptation means being further arranged to adapt the web page content to provide the adapted version in dependence on the output of the web page content analysis means.

4. An apparatus according to claim 3, wherein said web page content analysis means further comprises object detection means for detecting display objects in said web page content; and object size calculation means for calculating the size of said display objects.

5. An apparatus according to claim 3, wherein said web page content analysis means further comprises object detection means for detecting display objects in said web page content; and object function detecting means for determining the function of said detected objects.

6. An apparatus according to claim 3 wherein said web page content analysis means further comprises object detection means for detecting display objects in said web page content; object structure detecting means for determining the structure of said display objects; and object structure grouping means for grouping those objects which are determined to have the same or substantially the same structure.

7. An apparatus according to claim 3, wherein said web page content analysis means further comprises object detection means for detecting display objects in said web page content; object pattern detecting means for matching the detected display objects on the basis of their display patterns; and object pattern grouping means for clustering those display objects which match into groups.

8. An apparatus according to claim 2, wherein said adaptation means further comprises content transforming means arranged in use to apply one or more content transformations to said web page content.

9. An apparatus according to claim 8, and further comprising transformation evaluation means arranged to operate where more than one transformation is applied, and to evaluate each transformation after it is performed to determine whether the transformed content is capable of being displayed on the intended display device; wherein the transformation evaluating means is further arranged to control the content transforming means to apply the transformations in turn until such evaluation indicates that the transformed content is suitable for such display.

10. A method of providing web page content to a display device, the method comprising:
storing a plurality of different versions of the same web page content, each version being adapted for display on an intended display device having a set of one or more defined display characteristics;
receiving requests for web page content from display devices;
determining the one or more display characteristics of a display device from which a request for web content is received;
selecting a version of the web content stored in the content store in dependence on the determined display characteristics of the display device from which a request for web content was received, the selected version being that which is adapted for display on display devices having the determined display characteristics; and
transmitting the selected version to the display device.

11. A method according to claim 10, and further comprising the step of adapting said web page content in dependence on the determined display characteristics of the display device from which a request for web content is received so as to provide a version of the web page content adapted for display on the such device, said adapting step being operable in the event that the selecting step determines that there is no version in the content store which is adapted for display on the device having the determined display characteristics.

12. A method according to claim 11, wherein said adapting step (c) further comprises the steps of:
i) analysing the web page content to determine one or more characteristics thereof; and
ii) adapting the web page content to provide the adapted version in dependence on the results of the analysis step.

13. A method according to claim 12, wherein said analysing step (i) further comprises detecting display objects in said web page content, and calculating the size of said display objects.

14. A process according to claim 12, wherein said analysing step (i) further comprises detecting display objects in said web page content, and determining the function of said detected objects.

15. A process according to claim 12 wherein said analysing step (i) further comprises detecting display objects in said web page content; determining the structure of said display objects; and grouping those objects which are determined to have the same or substantially the same structure.

16. A process according to claim 12, wherein said analysing step (i) further comprises detecting display objects in said web page content; matching the detected display objects on the basis of their display patterns; and clustering those display objects which match into groups.

17. A process according to claim 12, wherein said adapting step further comprises applying one or more content transformations to said web page content.

18. A process according to claim 17, wherein where more than one transformation is applied, an evaluation is performed after each transformation to determine whether the transformed content is capable of being displayed on the intended display device, and the transformations are applied in turn until such evaluation indicates that the transformed content is suitable for such display.

19. A computer program or suite of programs so arranged such that when executed by a computer system it/they cause/s the system to perform the process of claim 10.

20. A modulated carrier signal incorporating data corresponding to the computer program or at least one of the suite of programs of claim 19.

21. A computer readable storage medium storing a computer program or at least one of suite of computer programs according to claim 19.
